(19) United States
(12) Patent Application Publication
(10) Pub. No.: US 2026/0139795 A1
(43) Pub. Date: May 21, 2026

(54) DEEP UNDERGROUND HYDROGEN STORAGE STRUCTURE AND ITS CONSTRUCTION METHOD

(71) Applicant: WSGRI Engineering & Surveying Incorporation Limited, Wuhan (CN)

(72) Inventors: Zhonghai Zang, Wuhan (CN); Hongyuan Ding, Wuhan (CN); Liang Xie, Wuhan (CN); Guangyu Yang, Wuhan (CN); Bin Chen, Wuhan (CN); Shaoqing Liu, Wuhan (CN); Zhongqi Pan, Wuhan (CN); Wenjie Jia, Wuhan (CN); Zhuang Chen, Wuhan (CN); Xiaoqian Luo, Wuhan (CN); Xiaogang Wang, Wuhan (CN); Chenxu Wang, Wuhan (CN); Zhixuan Tang, Wuhan (CN)

(21) Appl. No.: 19/011,977

(22) Filed: Jan. 7, 2025

Related U.S. Application Data
(63) Continuation of application No. PCT/CN2024/134589, filed on Nov. 26, 2024.

(30) Foreign Application Priority Data
Nov. 15, 2024 (CN) 2024116372296

(51) Int. Cl. F17C 1/00

(52) U.S. Cl. CPC F17C 1/007; F17C 2201/0104; F17C 2203/0604; F17C 2203/0624; F17C 2203/0639; F17C 2203/0678; F17C 2205/0107; F17C 2209/232; F17C 2221/012; F17C 2270/0142

(57) ABSTRACT

Disclosed is a deep underground hydrogen storage structure and its construction method. The structure comprises a concrete lining layer, a hydrogen barrier layer, a connecting framework, and multiple supporting arms; multiple supporting arms are spaced apart around the perimeter of the chamber, with each supporting arm having a connection end and a geotechnical end, and a grouting channel that connects the connection end and the geotechnical end. The grouting channel has a grout inlet at the connection end and a grouting port at the geotechnical end. This disclosure enables grouting reinforcement of the rock and soil layers around the geotechnical end through the grouting port of the grouting channel, achieving coordinated stress sharing between the deep underground hydrogen storage structure and the surrounding rock and soil layers, and significantly improving the safety performance of the deep underground hydrogen storage structure.

### FIELD OF THE DISCLOSURE

The disclosure relates to the technical field of deep underground hydrogen storage, in particular to a deep underground hydrogen storage structure and its construction method.

### BACKGROUND

With the continuous advancement of underground space development and utilization technology, deep underground hydrogen storage is regarded as the most feasible development direction among large-scale hydrogen storage technologies. Compared to other storage methods, deep underground hydrogen storage boasts advantages such as “large storage capacity, low cost, high safety, and excellent sealing performance.”

For example, a Chinese patent CN219754598U discloses a hydrogen storage structure utilizing abandoned mine caves. By locating the hydrogen storage facility within the mine caves, it leverages the relatively stable environmental factors such as temperature and humidity of the mine caves to achieve safe storage. Additionally, the surrounding rock and soil provide natural enclosing effects, enhancing the structural safety of the hydrogen storage facility.

During the construction of the initial support layer in the patent, the initial support layer template is set up, the drainage structure is arranged at the designated position and the geotextile is used for isolation and filtration, and finally the concrete is poured and cured. However, the initial support layer does not share loads with the inner wall of the mine cave, and the safety performance of the hydrogen storage structure needs to be improved.

### SUMMARY

The purpose of this disclosure is to overcome the aforementioned technical deficiencies and propose a deep underground hydrogen storage structure and its construction method that addresses the technical issue in existing technologies where the initial support layer of the hydrogen storage structure does not share loads with the inner wall of the mine cave, and the safety performance of the hydrogen storage structure needs improvement.

In order to achieve the above technical purposes, this disclosure adopted the following technical solutions:
This disclosure provides a deep underground hydrogen storage structure, comprising a concrete lining layer, a hydrogen barrier layer, a connecting framework, and multiple supporting arms, wherein:
the concrete lining layer has a chamber;
the hydrogen barrier layer is attached to the inner wall of the chamber;
the connecting framework is installed within the concrete lining layer and surrounds the perimeter of the chamber;
the multiple supporting arms are spaced apart and installed around the perimeter of the chamber, each supporting arm has a connection end and a geotechnical end, and is provided with a grouting channel that connects the connection end and the geotechnical end, the connection end is located within the concrete lining layer and is connected to the connecting framework; the geotechnical end is located outside the concrete lining layer; the grouting channel has a grout inlet located at the connection end and a grouting port located at the geotechnical end.

In some embodiments, the supporting arm comprises a hollow anchor bolt and an anchor bolt plate; the connection end and the geotechnical end are formed at the two ends of the hollow anchor bolt, and the hollow passage of the hollow anchor bolt constitutes the grouting channel; wherein, the connection end extends through to the side of the connecting framework that is close to the chamber, and the anchor bolt plate is located on the side of the connecting framework that is close to the chamber, connecting the connection end and the connecting framework.

In some embodiments, multiple grouting ports are provided, which are spaced apart along the circumferential direction and/or the extension direction of the supporting arm.

In some embodiments, the deep underground hydrogen storage structure further comprises a steel lining, the steel lining is disposed around the perimeter of the chamber and positioned between the concrete lining layer and the hydrogen barrier layer.

In some embodiments, the hydrogen barrier layer comprises multiple sets of hydrogen-resistant arcuate plates, these sets of hydrogen-resistant arcuate plates are arranged sequentially along the axial direction of the chamber; each set comprises multiple hydrogen-resistant arcuate plates, and these plates within the same set are disposed sequentially along the circumferential direction of the chamber.

In some embodiments, each hydrogen-resistant arcuate plate is provided with a tenon head and a tenon groove at its two ends along the circumference of the chamber, respectively, allowing the tenon head to be inserted into the tenon groove of an adjacent resistant arcuate plate within the same set.

In some embodiments, the two ends of each hydrogen-resistant arcuate plate along the circumference of the chamber are welding ends; the welding ends are inclined from the side farthest from the chamber towards the side closest to the chamber, in the direction towards the other welding end, forming welded sides.

In some embodiments, when two adjacent welded sides from the same set are spliced together, they form a weld seam with an angle α, where 45°≤α≤60°.

In some embodiments, the connecting framework is a steel cage placed within the concrete lining layer; and/or, the chamber is cylindrical in shape.

This disclosure also provides a construction method for the deep underground hydrogen storage structure, applicable to the deep underground hydrogen storage structure as claimed in claim 1, wherein the construction method comprises:
excavating soil required for the chamber according to drawing requirements, and installing multiple supporting arms in a circular array around the surrounding rock and soil layers with the axis of the chamber as the center; then, binding and installing the connecting framework according to design requirements, and connecting the connection end to the connecting framework; next, injecting concrete grout into the grouting channel through the grout inlet, allowing the concrete grout to be injected into the surrounding rock and soil layers through the grouting port;
according to design requirements, installing a circular support on the inside of chamber, and utilizing this circular support as an internal formwork for pouring concrete to form the concrete lining layer;
after the concrete lining layer has been formed, removing the circular support, and polishing and cleaning the inner wall of chamber; subsequently, gluing the hydrogen barrier layer to the inner wall of chamber.

Compared to the existing technology, the deep underground hydrogen storage structure provided in this disclosure features the connection end of the supporting arm extending into the concrete lining layer. Additionally, a connecting framework is installed within the concrete lining layer, and the connection end of the supporting arm is securely attached to this connecting framework, ensuring both the connection strength of the supporting arm and the strength of the concrete lining layer. Furthermore, the geotechnical end of the supporting arm is inserted into the soil-rock layer, and a grouting channel is set up within the supporting arm. Through the grouting port of this grouting channel, grouting reinforcement can be conducted on the soil-rock layer surrounding the geotechnical end, enabling the deep underground hydrogen storage structure to share loads with the surrounding soil-rock layer and significantly enhancing the safety performance of the structure.

### BRIEF DESCRIPTION OF THE DRAWINGS

FIG. 1 is a cross-sectional view of the deep underground hydrogen storage structure provided in an embodiment of this disclosure;

FIG. 2 is a partial schematic diagram of the deep underground hydrogen storage structure shown in FIG. 1;

FIG. 3 is a schematic diagram of the supporting arm in FIG. 1;

FIG. 4 is a schematic diagram of the hydrogen barrier layer in FIG. 1;

FIG. 5 is a schematic diagram of the hydrogen-resistant arcuate plate in FIG. 4;

FIG. 6 is a schematic diagram of a welding robot provided in one embodiment of this disclosure;

FIG. 7 is a schematic diagram of a welding robot provided in another embodiment of this disclosure;

FIG. 8 is a partial cross-sectional view of the welding robot shown in FIG. 6;

FIG. 9 is a partial schematic diagram of the welding robot shown in FIG. 8;

FIG. 10 is a partial schematic diagram of the material extrusion section in FIG. 8;

FIG. 11 is a schematic diagram of the welding robot preheating the weld seam in FIG. 6;

FIG. 12 is a schematic diagram of the welding robot extruding welding material onto the weld seam in FIG. 6;

FIG. 13 is a schematic diagram of the welding robot smoothing the welding material at the weld seam in FIG. 6.

### DETAILED DESCRIPTION OF PREFERRED EMBODIMENTS

In order to make the purpose, technical solutions, and advantages of this disclosure clearer, the following provides further detailed explanations of this disclosure in conjunction with the accompanying drawings and embodiments. It should be understood that the specific embodiments described here are solely for the purpose of explaining this disclosure and are not intended to limit it.

To address the technical issues in the prior art where the initial support layer of the hydrogen storage reservoir structure does not share loads with the inner wall of the mine tunnel, and where the safety performance of the hydrogen storage reservoir structure needs improvement, this disclosure provides a deep underground hydrogen storage structure that enables the structure to share loads with the surrounding soil-rock layer, significantly enhancing the safety performance of the deep underground hydrogen storage structure.

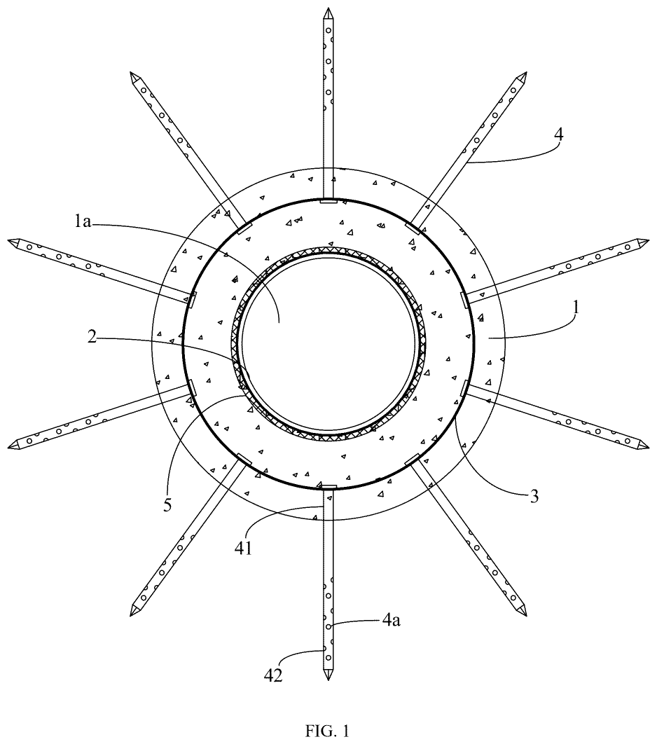

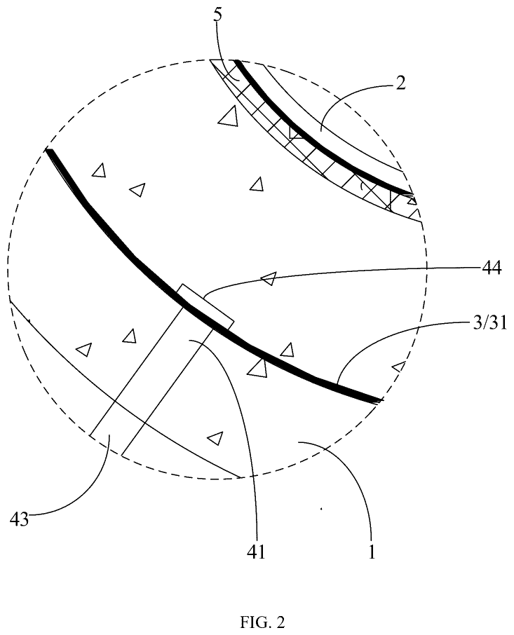

Please refer to FIG. 1 and FIG. 2, which are structural diagrams of a deep underground hydrogen storage structure in an embodiment of this disclosure. The deep underground hydrogen storage structure comprises a concrete lining layer 1, a hydrogen barrier layer 2, a connecting framework 3, and multiple supporting arms 4. The concrete lining layer 1 has a chamber 1a. The hydrogen barrier layer 2 is attached to the inner wall of the chamber 1a. The connecting framework 3 is installed within the concrete lining layer 1 and surrounds the perimeter of the chamber 1a. Multiple supporting arms 4 are spaced apart and installed around the perimeter of the chamber 1a. Each supporting arm 4 has a connection end 41 and a geotechnical end 42, and is provided with a grouting channel that connects the connection end 41 and the geotechnical end 42. The connection end 41 is located within the concrete lining layer 1 and is connected to the connecting framework 3. The geotechnical end 42 is located outside the concrete lining layer 1. The grouting channel has a grout inlet located at the connection end 41 and a grouting port 4a located at the geotechnical end 42.

In the deep underground hydrogen storage structure provided by this disclosure, the connection end 41 of the supporting arm 4 extends into the concrete lining layer 1, and a connecting framework 3 is installed within the concrete lining layer 1. The connection end 41 of the supporting arm 4 is fixedly connected to the connecting framework 3, ensuring the connection strength of the supporting arm 4 and the strength of the concrete lining layer 1. Simultaneously, the geotechnical end 42 of the supporting arm 4 is inserted into the soil-rock layer, and a grouting channel is provided within the supporting arm 4. Through the grouting port of the grouting channel, the soil-rock layer surrounding the geotechnical end 42 can be reinforced with grouting, enabling the deep underground hydrogen storage reservoir structure to share loads with the surrounding soil-rock layer and significantly enhancing the safety performance of the structure. It should be noted that in this embodiment, the chamber 1a is cylindrical. Additionally, each supporting arm 4 extends in a direction away from the chamber 1a, and its geotechnical end 42 is intended for insertion into the soil-rock layer.

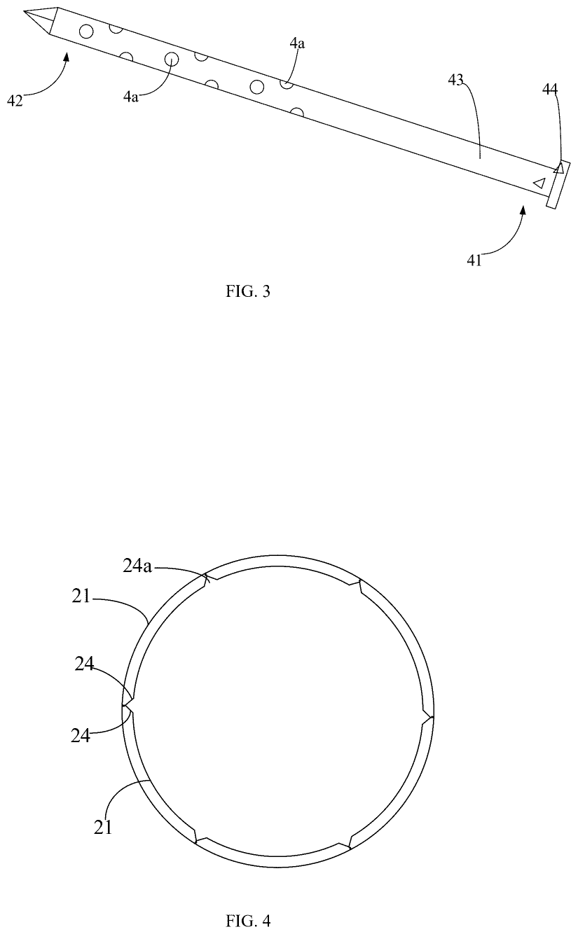

In one embodiment, please refer to FIG. 3, the supporting arm 4 comprises a hollow anchor bolt 43 and an anchor bolt plate 44. The connection end 41 and the geotechnical end 42 are formed at the two ends of the hollow anchor bolt 43, and the hollow passage of the hollow anchor bolt 43 constitutes the grouting channel. Specifically, the connection end 41 extends through to the side of the connecting framework 3 that is close to the chamber 1a, and the anchor bolt plate 44 is located on the side of the connecting framework 3 that is close to the chamber 1a, connecting the connection end 41 and the connecting framework 3.

In this embodiment, the hollow anchor bolt 43 is connected to the connecting framework 3 via the anchor bolt plate 44. The anchor bolt plate 44 is located at the connection end 41 of the hollow anchor bolt 43, which improves the stress distribution at the end and enhances the support effect on the rock wall, facilitating the transmission of prestress through the hollow anchor bolt 43. It should be noted that the specific configuration of the connecting framework 3 is not limited, as long as it can strengthen the concrete lining layer 1 and increase the connection strength of the hollow anchor bolt 43. In one embodiment, the connecting framework 3 is configured in the form of reinforcing fibers. In another embodiment, the connecting framework 3 is configured as a steel plate with through-holes corresponding to the hollow anchor bolt 43. However, in this embodiment, the connecting framework 3 is configured in the form of a steel cage 31.

In an embodiment, multiple grouting ports 4a are provided, which are spaced apart along the circumferential direction and/or the extension direction of the supporting arm 4.

In this embodiment, multiple grouting ports 4a are arranged at intervals along both the circumferential and axial directions of the hollow anchor bolt 43. This enables the geotechnical end 42 of the hollow anchor bolt 43 to consolidate uniformly with the soil and rock layers, further enhancing the cooperative stress-bearing capacity between the hollow anchor bolt 43 and the soil and rock layers.

In an embodiment, the deep underground hydrogen storage structure further comprises a steel lining 5. The steel lining 5 is disposed around the perimeter of the chamber 1a and positioned between the concrete lining layer 1 and the hydrogen barrier layer 2.

In this embodiment, a steel lining 5 is also installed between the concrete lining layer 1 and the hydrogen barrier layer 2 to further enhance the barrier capability for hydrogen storage, achieving a good seal for high-pressure hydrogen. It should be noted that in this scheme, the hydrogen barrier layer 2 is a polymer hydrogen barrier layer, which is bonded to the inner surface of the steel lining 5 using epoxy resin adhesive to form a double sealing structure.

In an embodiment, please refer to FIG. 4, the hydrogen barrier layer 2 comprises multiple sets of hydrogen-resistant arcuate plates 21. These sets of hydrogen-resistant arcuate plates 21are arranged sequentially along the axial direction of the chamber 1a. Each set comprises multiple hydrogen-resistant arcuate plates 21, and these plates within the same set are disposed sequentially along the circumferential direction of the chamber 1a.

In this embodiment, the hydrogen barrier layer 2 is configured as multiple sets of annularly arranged hydrogen-resistant arcuate plates 21 to facilitate assembly. Each set of hydrogen-resistant arcuate plates 21 is designed as multiple splicable units to enhance transportation and construction convenience. It should be noted that in this scheme, the hydrogen-resistant arcuate plates 21 are made of polymer materials to improve their ability to prevent hydrogen molecules from escaping.

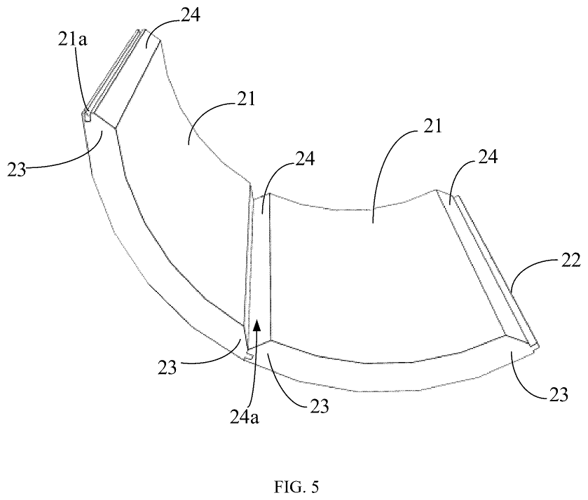

In an embodiment, please refer to FIG. 5, each hydrogen-resistant arcuate plate 21 is provided with a tenon head 22 and a tenon groove 21a at its two ends along the circumference of the chamber 1a, respectively, allowing the tenon head 22 to be inserted into the tenon groove 21a of an adjacent resistant arcuate plate21 within the same set.

In this embodiment, a tenon head 22 and a tenon groove 21a are provided at the two ends of each hydrogen-resistant arcuate plate 21 along its circumference. During assembly, the tenon head 22 can be inserted into the tenon groove 21a of an adjacent hydrogen-resistant arcuate plate 21, enabling the splicing and positioning of the polymer hydrogen-resistant arcuate plates 21. This improves the convenience and stability during assembly.

In an embodiment, the two ends of each hydrogen-resistant arcuate plate 21 along the circumference of the chamber 1a are welding ends 23. The welding ends 23 are inclined from the side farthest from the chamber 1a towards the side closest to the chamber 1a, in the direction towards the other welding end 23, forming welded sides 24.

In this embodiment, a welded side 24 is also provided at the end of each hydrogen-resistant arcuate plate 21 along its circumference. When welding two adjacent hydrogen-resistant arcuate plates 21, weld material is applied to the corresponding two welded sides 24, thereby increasing the welding area and enhancing the connection strength between the hydrogen-resistant arcuate plates 21.

In an embodiment, when two adjacent welded sides 24 from the same set are spliced together, they form a weld seam 24a with an angle α, where 45°≤α≤60°.

In this embodiment, the angle of the weld seam 24a is controlled between 45° and 60° to prevent the ends of the hydrogen-resistant arcuate plates 21 from being too thin and thus reducing their strength, while ensuring that the welded sides 24 have a sufficiently large surface area to expand the welding surface. Additionally, a weld seam 24a with an appropriate angle ensures that the weld material, once welded, can fill the weld seam 24a properly without protruding into the chamber 1a.

Furthermore, this disclosure also provides a constructing method for the underground hydrogen storage structure described above. The constructing method for the underground hydrogen storage structure comprises the following steps:
excavating the soil required for the chamber 1a according to drawing requirements, and installing multiple supporting arms 4 in a circular array around the surrounding rock and soil layers with the axis of the chamber 1a as the center. Then, binding and installing the connecting framework 3 according to design requirements, and connecting the connection end 41 to the connecting framework 3. Next, injecting concrete grout into the grouting channel through the grout inlet, allowing the concrete grout to be injected into the surrounding rock and soil layers through the grouting port 4a;
according to the design requirements, installing a circular support on the inside of chamber 1a, and utilizing this circular support as an internal formwork for pouring concrete to form the concrete lining layer 1;
after the concrete lining layer 1 has been formed, removing the circular support, and polishing and cleaning the inner wall of chamber 1a. Subsequently, gluing the hydrogen barrier layer 2 to the inner wall of chamber 1a.

It should be noted that for the embodiment where a steel lining 5 is provided, the specific construction method is as follows:
S1, installation of support structure: excavating the internal earthwork of the deep underground hydrogen storage structure according to the drawing requirements. Installing multiple hollow anchor bolts 43 in a circular array centered on the axis of the structure and extending into the surrounding rock and soil layers. Next, binding and installing the steel cage 31 inside the high-performance concrete lining layer 1 as per the design requirements. Welding the anchor bolt plates 44 at the upper ends of the hollow anchor bolts 43 to the steel cage 31. Finally, using a grouting machine to inject grout through the grouting ports 4a at the lower ends of the hollow anchor bolts 43 into the surrounding rock and soil layers for reinforcement, completing the installation of the hollow anchor bolts 43.
S2, installation of the steel lining 5: fabricating and installing the steel lining 5 at a steel plate processing factory according to the design requirements. Using mechanical equipment to push the entire steel lining 5 into the interior of the cavern of the deep underground hydrogen storage structure, completing the installation of the steel lining 5.
S3, installation of high-performance concrete lining layer 1: setting up multiple circular supports inside the steel lining 5 according to the design requirements to reinforce and support it. Using the steel lining 5 as an internal formwork for pouring high-performance concrete. Employing a vibrator to compact and cure the high-performance concrete until it sets and forms properly. At this point, the installation of the high-performance concrete lining layer 1 is completed. 1
S4, installation of high-molecular hydrogen barrier layer 2: demolishing the circular supports inside the steel lining 5 sequentially from the inside out. Then, grinding and cleaning the inner side of the steel lining 5. Applying epoxy resin adhesive to attach and fix the high-molecular hydrogen-resistant arcuate plates 21. Subsequently, using a welding robot to weld and fix the circumferentially spliced high-molecular hydrogen-resistant arcuate plates 21 sequentially to form an integral high-molecular hydrogen barrier layer 2. At this point, the construction of the deep underground hydrogen storage structure is completed.

Furthermore, it should be noted that during the welding of the hydrogen-resistant arcuate plates 21, the V-shaped weld seams 24a between the circumferentially spliced high-molecular hydrogen-resistant arcuate plates 21 are first preheated to bring their surfaces to a molten state. Simultaneously, the welding material is also preheated. Then, the preheated welding material is allowed to continue to extrude and, after being heated to a molten state, is squeezed out to fill the V-shaped weld seams 24a. Finally, the welding material at the V-shaped weld seams 24a is smeared and leveled to prevent poor welding quality caused by uneven welding material distribution.

To better understand this disclosure, the technical solution presented herein will be described in detail with reference to FIG. 1 to FIG. 5.

In this scheme, the hollow anchor bolt 43 and anchor bolt plate 44 of the supporting arm 4 are fixedly connected to the steel cage 31 within the high-performance concrete lining layer 1. Additionally, grouting reinforcement can be conducted on the surrounding rock and soil layers through the grouting port 4a on the hollow anchor bolt 43, enabling the deep underground hydrogen storage structure to share loads with the surrounding rock and soil layers and significantly enhancing the safety performance of the deep underground hydrogen storage structure.

Furthermore, the high-molecular hydrogen barrier layer 2 is designed as multiple splicable hydrogen-resistant arcuate plates 21, which are arcuate sheet materials, facilitating convenient construction and shortening the construction period. These arcuate plates are welded into an integral structure using welding robots to achieve good sealing against high-pressure hydrogen. Additionally, a connection structure featuring tenon heads 22 and tenon grooves 21a is provided between adjacent high-molecular materials, enabling quick positioning and tight fitting of the materials, reducing construction errors, and ensuring the effectiveness of the high-molecular hydrogen barrier layer 2.

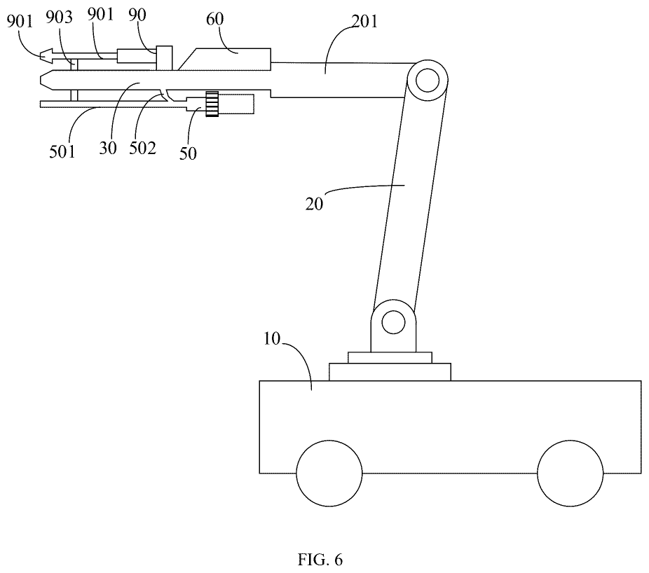

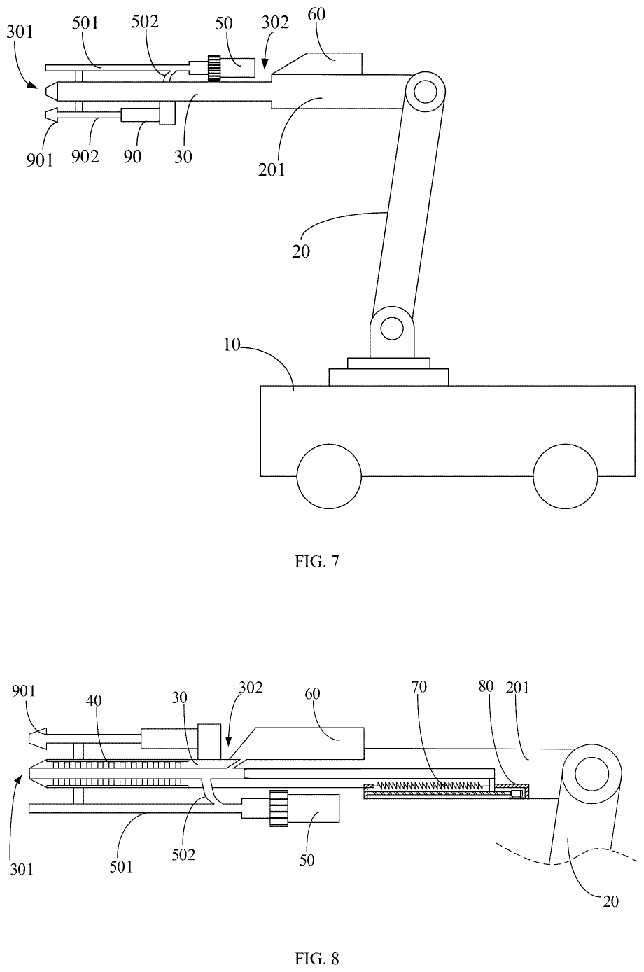

Please note, referring to FIG. 6 to FIG. 8, the aforementioned welding robot comprises a trolley 10, a robotic arm 20, a welding gun 30, a heating section 40, a hot air blower 50, a main hot air pipe 501, and a branch hot air pipe 502. The robotic arm 20 is mounted on the trolley 10 and is capable of moving relative to the trolley 10. The welding gun 30 is installed on the robotic arm 20 and has a material feeding channel 30a for conveying welding material, with a welding connection end 301 and a material inlet end 302 located at its two ends. The heating section 40 is disposed on the welding gun 30, positioned between the welding connection end 301 and the material inlet end 302. The hot air blower 50 is mounted on the robotic arm 20. The main hot air pipe 501 connects to the outlet of the hot air blower 50, with its air outlet direction aligning with the material outlet direction of the welding gun 30. The branch hot air pipe 502 connects the outlet of the hot air blower 50 to the material inlet end 302.

When the welding robot 100 is in operation, it first moves the robotic arm 20 to a position adjacent to the area to be welded using the trolley 10. Then, it adjusts the robotic arm 20 to position it at the weld seam 24a. The hot air blower 50 is activated, and part of the hot air is blown through the main hot air pipe 501 onto the weld seam 24a to preheat it, bringing its surface to a molten state. Simultaneously, another part of the hot air from the hot air blower 50 is blown through the main hot air pipe 501 to the material inlet end 302 of the welding gun 30 to preheat the welding material being fed into the material feeding channel 30a. This allows the welding material to be quickly heated to a molten state by the heating section 40 as it moves towards the welding connection end 301, and finally, it is discharged from the welding connection end 301 to fill the weld seam 24a, completing the welding process. In this scheme, both the weld seam 24a and the welding material can be preheated simultaneously, improving welding efficiency and quality. Additionally, the structure is relatively simple, saving investment costs. By using welding material to fill the weld seam 24a for welding, it is capable of directly welding non-conductive polymer materials, demonstrating good applicability.

It should be noted that in one embodiment, the robotic arm 20 comprises at least two segments of connecting arms, with the two connecting arms at the ends being capable of moving relative to each other in any direction, allowing the mobile end 201 of the robotic arm 20 to move in any direction relative to the trolley 10. One end of the connecting arms is mounted on the trolley 10 via a rotating base. Specifically, the connecting arms are hingedly connected to the rotating base through ear plates. It should be understood that the specific structure and working principle of the robotic arm 20 are prior art and will not be elaborated here.

In one embodiment, the welding robot 100 further comprises a welding material bin 60 and a material extrusion section 70. The welding material bin 60 is disposed on the robotic arm 20 and is connected to the material inlet end 302. The material extrusion section 70 is disposed on the welding gun 30 and is used to propel the welding material from the material inlet end 302 towards the welding connection end 301.

In this embodiment, the welding material bin 60 is also placed on the robotic arm 20, enabling a continuous supply of welding material into the material feeding channel 30a of the welding gun 30. The material extrusion section 70 then propels the welding material in the material feeding channel 30a towards the welding connection end 301, enhancing the level of automation.

It should be noted that there are no restrictions on the configuration of the material extrusion section 70, as long as it can propel the welding material from the material inlet end 302 to the welding connection end 301. In one embodiment, the material extrusion section 70 is configured as an electric extruder rod, which uses the rod to extrude the welding material. In another embodiment, the material extrusion section 70 is configured as a hydraulic pusher rod, which also uses the rod to exert pressure on the welding material for extrusion.

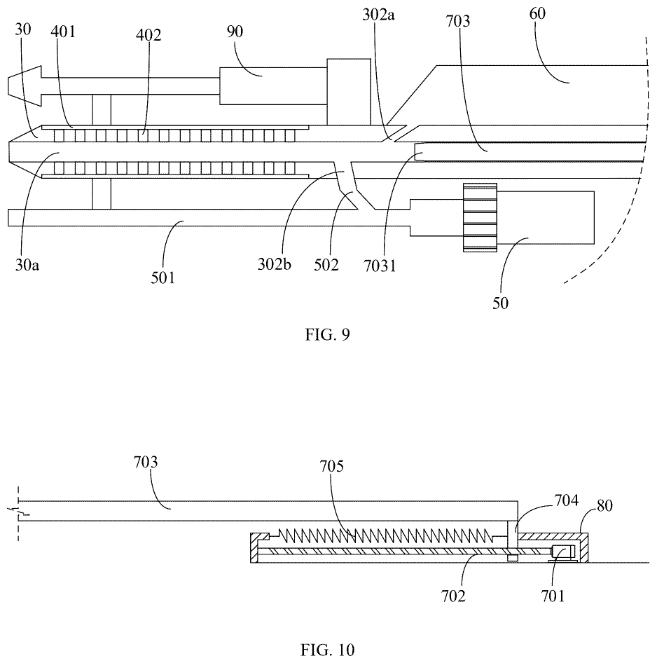

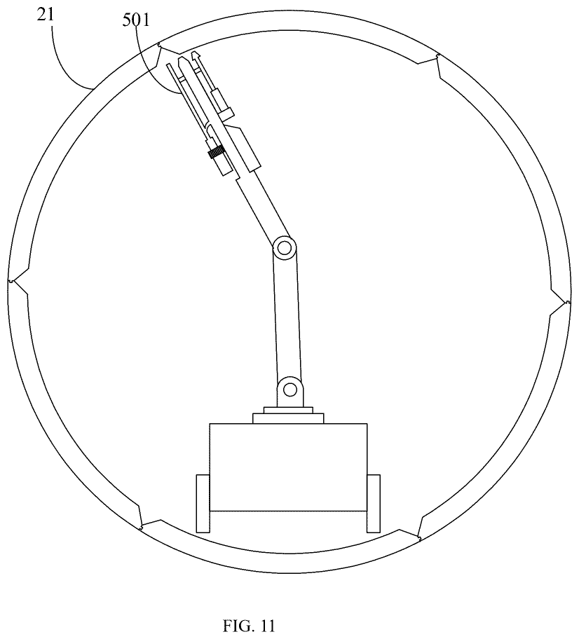

In one embodiment, please refer to FIG. 8 to FIG. 10, the material extrusion section 70 comprises a driving motor 701, a driving screw rod 702, a material extrusion rod 703, and a driving nut 704. The driving motor 701 is disposed on the robotic arm 20. The driving screw rod 702 is drivingly connected to the output shaft of the driving motor 701 and extends along the arrangement direction of the material inlet end 302 and the welding connection end 301. One end of the material extrusion rod 703 is inserted into the material feeding channel 30a and can move axially, while the other end is located outside the material feeding channel 30a. The driving nut 704 is sleeved outside the driving screw rod 702 and connected to the end of the material extrusion rod 703 that is outside the material feeding channel 30a, converting the rotation of the driving screw rod 702 into axial movement of the material extrusion rod 703.

In this embodiment, the rotation of the output shaft of the driving motor 701 drives the driving screw rod 702 to rotate synchronously. Through the cooperation between the driving screw rod 702 and the driving nut 704, the rotation of the driving screw rod 702 is converted into linear movement of the material extrusion rod 703, thereby achieving material extrusion. At the same time, this configuration keeps the driving motor 701 away from the heat source, ensuring a stable and reliable structure.

In one embodiment, the welding robot 100 further comprises an installation box 80. The installation box 80 is mounted on the robotic arm 20 and has an installation cavity. It also has a connecting hole that communicates the exterior with the installation cavity, facing the direction towards the material inlet end 302. The driving motor 701, driving screw rod 702, and driving nut 704 are located within the installation cavity, while the end of the material extrusion rod 703 that is outside the material feeding channel 30a extends into the installation cavity through the connecting hole.

In this embodiment, the driving motor 701, driving screw rod 702, and driving nut 704 are placed within the installation cavity of the installation box 80, providing protection for these components.

In one embodiment, one of the inner wall of the installation cavity and the material extrusion rod 703 is provided with a limiting slot, and the other is provided with a limiting block. The limiting slot extends along the axial direction of the material extrusion rod 703, and the limiting block is engaged in the limiting slot to prevent the material extrusion rod 703 from rotating around its axis.

In this embodiment, the cooperation of the limiting slot and the limiting block prevents the material extrusion rod 703 from being driven to rotate synchronously by the driving screw rod 702. This ensures that the driving nut 704 can stably convert the rotation of the driving screw rod 702 into linear movement of the material extrusion rod 703, improving stability.

In one embodiment, please refer to FIG. 8 and FIG. 9. The end of the material extrusion rod 703 located within the material feeding channel 30a is the extrusion end 7031. The material inlet end 302 has a material inlet 302a that communicates with the welding material bin 60. The connection point between the branch hot air pipe 502 and the material inlet end 302 is located on the side of the material inlet 302a closer to the welding connection end 301. The material extrusion section 70 further includes a return spring 705, which connects the robotic arm 20 and the driving nut 704. The return spring 705 is used to drive the extrusion end 7031 to reset from a position close to the welding connection end 301 to the side of the material inlet 302a farther from the welding connection end 301.

In this embodiment, the material inlet end 302 is provided with an air inlet 302b, which is located on the side of the material inlet 302a closer to the welding connection end 301 and is connected to the branch hot air pipe 502. After the material extrusion rod 703 extrudes the welding material at the front end of the material feeding channel 30a, the driving motor 701 stops driving the material extrusion rod 703 to continue moving towards the welding connection end 301. Under the action of the return spring 705, the material extrusion rod 703 can quickly reset, so that the extrusion end 7031 is positioned on the side of the material inlet 302a farther from the air inlet 302b. This ensures stable entry and preheating of the welding material into the material feeding channel 30a. It should be noted that in one embodiment, the torque of the return spring 705 is greater than the starting torque of the driving motor 701 but less than its working torque, allowing the material extrusion rod 703 to reset.

In one embodiment, the welding robot 100 further comprises an electric push rod 90 and a smear head 901. The electric push rod 90 is disposed on the robotic arm 20, and its telescopic rod 902 extends and retracts along the arrangement direction of the material inlet end 302 and the welding connection end 301. The smear head 901 is mounted on the end of the telescopic rod 902.

In this embodiment, the robotic arm 20 is also equipped with an electric push rod 90 and a smear head 901. As such, after the welding gun 30 fills the weld seam 24a with welding material, the robotic arm 20 can cooperate with the electric push rod 90 to drive the smear head 901 to smooth the welding material at the weld seam 24a, preventing poor welding quality due to uneven welding material.

In one embodiment, the smear head 901 and the main hot air pipe 501 are respectively disposed on opposite sides of the welding gun 30 in a radial direction, and are spaced apart from the welding gun 30.

In this embodiment, the main hot air pipe 501 and the smear head 901 are placed on opposite sides of the welding gun 30 in a radial direction. When the robotic arm 20 drives the welding gun 30 to move towards the side where the main hot air pipe 501 is located, the main hot air pipe 501 first preheats the area of the weld seam 24a. Then, the welding gun 30 outputs the welding material, and finally, the smear head 901 smooths the welding material. This makes the entire process smoother, further improving welding quality and efficiency.

In one embodiment, one of the outer wall of the welding gun 30 and the telescopic rod 902 is provided with a sliding groove, and the other is provided with a slider 903. The sliding groove extends along the axial direction of the telescopic rod 902, and the slider 903 is disposed within the sliding groove.

In this embodiment, a slider 903 and a sliding groove are provided between the welding gun 30 and the telescopic rod 902 of the electric push rod 90 to provide guidance and support for the telescopic rod 902. This ensures the stability of the smear head 901 when smoothing the welding material.

It should be noted that the configuration of the heating section 40 is not limited, as long as it can heat the welding material inside the welding gun 30 to a molten state. In one embodiment, the heating section 40 is configured in the form of electromagnetic heating, while in another embodiment, it is configured in the form of fuel heating.

In one embodiment, the heating section 40 comprises an insulating cylinder 401 and multiple electric heating rings 402. The insulating cylinder 401 is sleeved outside the welding gun, and the multiple electric heating rings 402 are arranged annularly around the welding gun 30, spaced apart along the arrangement direction of the material inlet end 302 and the welding connection end 301, and located inside the insulating cylinder 401.

In this embodiment, the heating section 40 is configured in the form of an insulating cylinder 401 and multiple electric heating rings 402. The electric heating rings 402 generate heat when energized to heat the welding material inside the welding gun 30, and the insulating cylinder 401 provides thermal insulation and heat preservation, accelerating the heating speed of the welding material.

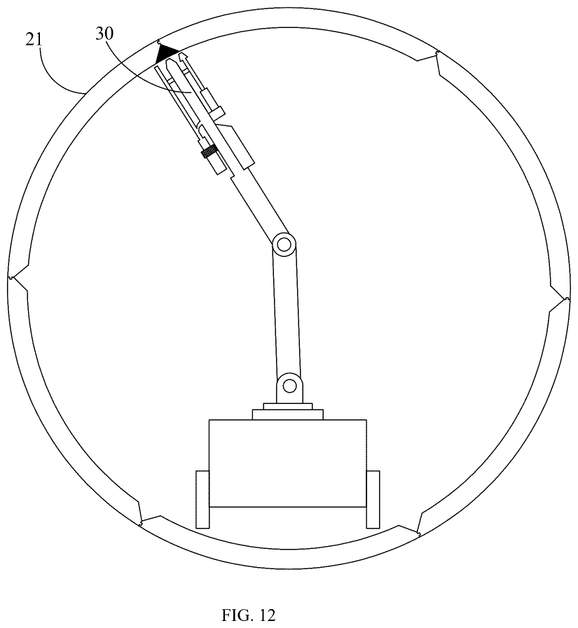

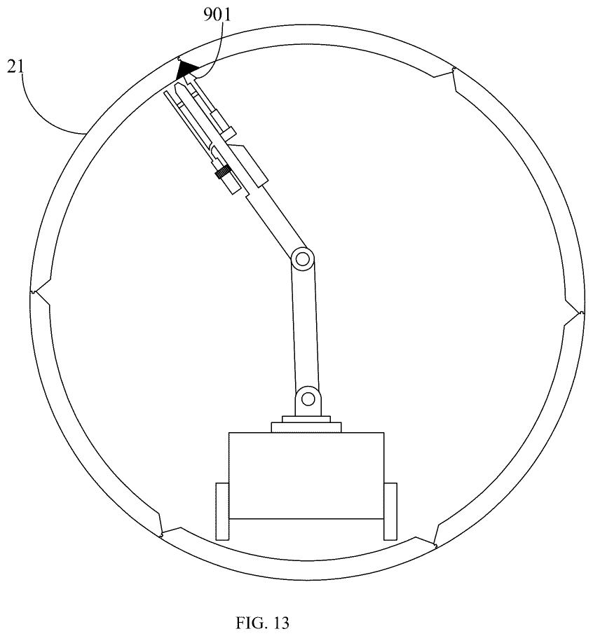

Here is a detailed explanation of the technical solution for the welding robot, with reference to FIG. 6 to FIG. 13:
Firstly, the weld seam 24a between the circumferentially spliced hydrogen-resistant arcuate plates 21 is preheated through the main hot air pipe 501 connected to the hot air blower 50, making its surface molten. Simultaneously, the welding material entering the material feeding channel 30a is preheated by the branch hot air pipe 502 also connected to the hot air blower 50. Next, the driving motor 701 is activated to rotate the driving screw rod 702, which in turn drives the material extrusion rod 703 to push the preheated welding material forward. After being heated to a molten state by the electric heating ring 402, the welding material is extruded and fills the weld seam 24a. Finally, the electric push rod 90 is activated to drive the smear head 901 to smooth the welding material at the weld seam 24a, preventing poor welding quality due to uneven welding material.

The specific embodiments described above do not constitute limitations on the scope of protection of this disclosure. Any other corresponding changes and modifications made based on the technical concepts of this disclosure shall be included within the scope of protection of the claims of this disclosure.

What is claimed is:

1. A deep underground hydrogen storage structure, comprising a concrete lining layer, a hydrogen barrier layer, a connecting framework, and multiple supporting arms, wherein:
the concrete lining layer has a chamber;
the hydrogen barrier layer is attached to the inner wall of the chamber;
the connecting framework is installed within the concrete lining layer and surrounds the perimeter of the chamber;
the multiple supporting arms are spaced apart and installed around the perimeter of the chamber, each supporting arm has a connection end and a geotechnical end, and is provided with a grouting channel that connects the connection end and the geotechnical end, the connection end is located within the concrete lining layer and is connected to the connecting framework; the geotechnical end is located outside the concrete lining layer; the grouting channel has a grout inlet located at the connection end and a grouting port located at the geotechnical end.

2. The deep underground hydrogen storage structure according to claim 1, wherein the supporting arm comprises a hollow anchor bolt and an anchor bolt plate; the connection end and the geotechnical end are formed at the two ends of the hollow anchor bolt, and the hollow passage of the hollow anchor bolt constitutes the grouting channel; wherein, the connection end extends through to the side of the connecting framework that is close to the chamber, and the anchor bolt plate is located on the side of the connecting framework that is close to the chamber, connecting the connection end and the connecting framework.

3. The deep underground hydrogen storage structure according to claim 1, wherein multiple grouting ports are provided, which are spaced apart along the circumferential direction and/or the extension direction of the supporting arm.

4. The deep underground hydrogen storage structure according to claim 1, wherein the deep underground hydrogen storage structure further comprises a steel lining, the steel lining is disposed around the perimeter of the chamber and positioned between the concrete lining layer and the hydrogen barrier layer.

5. The deep underground hydrogen storage structure according to claim 1, wherein the hydrogen barrier layer comprises multiple sets of hydrogen-resistant arcuate plates, these sets of hydrogen-resistant arcuate plates are arranged sequentially along the axial direction of the chamber; each set comprises multiple hydrogen-resistant arcuate plates, and these plates within the same set are disposed sequentially along the circumferential direction of the chamber.

6. The deep underground hydrogen storage structure according to claim 5, wherein each hydrogen-resistant arcuate plate is provided with a tenon head and a tenon groove at its two ends along the circumference of the chamber, respectively, allowing the tenon head to be inserted into the tenon groove of an adjacent resistant arcuate plate within the same set.

7. The deep underground hydrogen storage structure according to claim 5, wherein the two ends of each hydrogen-resistant arcuate plate along the circumference of the chamber are welding ends; the welding ends are inclined from the side farthest from the chamber towards the side closest to the chamber, in the direction towards the other welding end, forming welded sides.

8. The deep underground hydrogen storage structure according to claim 7, when two adjacent welded sides from the same set are spliced together, they form a weld seam with an angle α, where 45°≤α≤60°.

9. The deep underground hydrogen storage structure according to claim 1, wherein the connecting framework is a steel cage placed within the concrete lining layer; and/or, the chamber is cylindrical in shape.

10. A construction method for the deep underground hydrogen storage structure, applicable to the deep underground hydrogen storage structure as claimed in claim 1, wherein the construction method comprises:
excavating soil required for the chamber according to drawing requirements, and installing multiple supporting arms in a circular array around the surrounding rock and soil layers with the axis of the chamber as the center; then, binding and installing the connecting framework according to design requirements, and connecting the connection end to the connecting framework; next, injecting concrete grout into the grouting channel through the grout inlet, allowing the concrete grout to be injected into the surrounding rock and soil layers through the grouting port;
according to design requirements, installing a circular support on the inside of chamber, and utilizing this circular support as an internal formwork for pouring concrete to form the concrete lining layer;
after the concrete lining layer has been formed, removing the circular support, and polishing and cleaning the inner wall of chamber; subsequently, gluing the hydrogen barrier layer to the inner wall of chamber.
